(19) United States
(12) Patent Application Publication
(10) Pub. No.: US 2026/0203171 A1
(43) Pub. Date: Jul. 16, 2026

(54) TECHNOLOGIES FOR PROVIDING MEDIA CONTENT FOR SERVICING STORAGE ENCLOSURES

(71) Applicant: Dell Products L.P., Round Rock, TX (US)

(72) Inventor: Anton Rang, Houlton, WI (US)

(21) Appl. No.: 19/026,014

(22) Filed: Jan. 16, 2025

(51) Int. Cl. G06F 11/14; G06F 1/18

(52) U.S. Cl. CPC G06F 11/1464; G06F 1/187; G06F 11/1448; G06F 2201/86

(57) ABSTRACT

The subject technology relates to providing media content for servicing storage enclosures. For instance, media files stored in memory of a storage enclosure are usable to generate respective instructional content related to performing respective service operations on the storage enclosure. A network connection can be established between a network interface of the storage enclosure and an external device over a network. An embedded controller of the storage enclosure can detect a triggering event signaling an uploading process, and, in response to detecting the triggering event, the embedded controller can upload, using the network connection, the media files to the external device for storage on the external device. The triggering event may include the embedded controller being determined to have received a request from the external device. The external device may be a primary controller configured to manage storage resources associated with the storage enclosure and other storage enclosures.

### BACKGROUND

In modern data systems, storage enclosures containing hard drives or flash storage are commonly used to provide scalable storage and are employed across a wide array of applications. Storage enclosures support various types of storage devices, including both hard disk drives (HDDs) and solid-state drives (SSDs). The versatility of storage enclosures allows them to be utilized by numerous products, including different types of network or primary controllers, each of which may support multiple types of storage enclosures. Using storage enclosures helps to ensure that the user interface (UI), associated with, for example, the primary controller, accurately reflects the specific type of storage enclosures being employed with the data system. This accuracy helps to identify and replace components within the different storage enclosures.

The above-described context with respect to conventional computing systems is merely intended to provide an overview of current technology and is not intended to be exhaustive. Other contextual description, and corresponding benefits of some of the various non-limiting embodiments described herein, will become further apparent upon review of the following detailed description.

### SUMMARY

The following presents a simplified summary of the disclosed subject matter to provide a basic understanding of various example embodiments described herein. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a storage enclosure is described herein. The storage enclosure may include an outer encasement housing drive bays configured to receive respective disk drives. The drive bays may include respective power and data connections for operation of the respective disk drives installed in the drive bays. The storage enclosure may further include a memory on which is stored media files usable to generate respective instructional content related to performing respective service operations with respect to the storage enclosure. The storage enclosure may further include a network interface. The storage enclosure may further include an embedded controller configured to detect a triggering event signaling an uploading process, and, in response to detection of the triggering event, upload, via the network interface to an external device for storage thereon, the media files.

In an example embodiment, a system is described herein. The system may include storage enclosures in a data storage system, and a primary controller, connected to each of the storage enclosures, configured to manage storage resources associated with the storage enclosures. The storage enclosures each may include a common configuration that includes: drive bays configured to receive respective disk drives, the drive bays may include respective power and data connections for operation of the respective disk drives installed in the drive bays; a memory on which is stored media files usable to generate respective instructional content related to performing respective service operations with respect to the storage enclosure; and an embedded controller configured to detect a first triggering event signaling an uploading process applicable to media files, and, in response to detection of the first triggering event, upload the media files via a network interface to the primary controller. The primary controller may further configured to: receive the media files uploaded from each of the storage enclosures; monitor respective operational statuses of the storage enclosures; as a result of monitoring the respective operational statuses and based on a defined criterion, detect a second triggering event signaling a service request applicable to an identified storage enclosure of the storage enclosures; match the service request to a corresponding service operation of the respective service operations; based on the service request being matched to the corresponding service operation, identify a select media file from the media files uploaded from the identified storage enclosure that may include instructional content of the respective instructional content applicable to performing the corresponding service operation; and initiate rendering, via a graphical user interface connected to the primary controller, the instructional content contained in the media file.

In an example embodiment, a method is described herein. The method may include storing media files on at least one memory of a storage enclosure. The media files may be usable to generate respective instructional content related to performing respective service operations on the storage enclosure. The method may further include establishing a network connection between a network interface of the storage enclosure and an external device over a network. The method may further include detecting, by an embedded controller of the storage enclosure, a triggering event signaling an uploading process. The method may further include, in response to detecting the triggering event, uploading, by the embedded controller using the network connection, the media files to the external device for storage on the external device. The triggering event may include the embedded controller being determined to have received a request from the external device.

To the accomplishment of the foregoing and related ends, the disclosed subject matter includes one or more of the features hereinafter more fully described. The following description and the annexed drawings set forth in detail certain illustrative example embodiments of the subject matter. However, these example embodiments are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Features and advantages of the present technique will become more apparent from the following detailed description of example embodiments thereof taken in conjunction with the accompanying drawings in which:

FIG. 1 illustrates an example system including storage enclosures and a primary controller according to various example embodiments;

FIG. 2 illustrates the front panel of a storage enclosure according to various example embodiments;

FIG. 3 is a schematic diagram of an interior of a storage enclosure according to various example embodiments;

FIG. 4 is an example of media identifying a particular disk drive within a storage enclosure according to various example embodiments;

FIG. 5 is an alternative example of media identifying a particular disk drive within a storage enclosure according to various example embodiments;

FIG. 6 is an alternative example of media identifying a particular disk drive within a storage enclosure according to various example embodiments;

FIG. 7 is an alternative example of media identifying a particular disk drive within a storage enclosure according to various example embodiments;

FIG. 8 is an alternative example of media demonstrating steps for removing a disk drive from a storage enclosure according to various example embodiments;

FIG. 9 illustrates a method related to providing media files on a storage enclosure according to various example embodiments;

FIG. 10 illustrates a method related to a primary controller managing media files related to attached storage enclosures according to various example embodiments; and

FIG. 11 is an example of an embodiment of a computer system that may utilize the techniques described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments. Like reference numerals have been used to illustrate like components across the figures.

In modern data systems, storage enclosures containing hard drives or flash storage are commonly used to provide scalable storage and are employed across a wide array of applications. Storage enclosures can support various types of storage devices, which can include both hard disk drives (HDDs) and solid-state drives (SSDs). The versatility of storage enclosures allows them to be utilized by numerous products, including different types of network controllers, each of which may support multiple types of storage enclosures. Using such storage enclosures helps to ensure that the instructional content available for them through an associated user interface (UI), for example, a UI provided by a primary controller, is maintained with media that accurately reflects the specific type of storage enclosures being used. Such media may include images and videos related to the performance of maintenance or service operations. For example, images or videos may be included that assist technicians to identify and replace particular components within an included type of storage enclosure.

However, the media often lags behind and is not representative of the storage enclosures within a given network. One of the reasons for this is how frequently data center storage arrangements can change, with new devices being constantly added or existing ones being moved between networks. Another reason for this is that typically the media maintained by the primary controller must be manually updated to reflect device changes to the network. Such circumstances often result in outdated information and inefficient management of the storage enclosures, which can lead to complications in identifying and replacing components, ultimately affecting the overall performance of the storage system.

According to example embodiments, the present application proposes to store media directly on the storage enclosures themselves and enable automatic uploads to the primary controller to which they are attached. For example, by embedding images and possibly videos of the storage enclosure and its components within the firmware of the enclosure, present embodiments more effectively ensure that current and accurate media is available. These media files can be accessed through mechanisms already in use, such as a REST API or other network-connected interfaces. In cases where no network is used, such as with SCSI-attached enclosures, the monitoring functionality and media can be provided via custom commands or read-only storage accessible at a known location, such as a dedicated SCSI Logical Unit Number (LUN).

According to example embodiments, the primary controller connected to the storage enclosure, such as a network-attached storage controller or a primary storage array controller, can retrieve these images and videos to display them as part of its user interface. When procedures such as drive replacement are implicated, the relevant media can be shown to guide the technician or user. This approach eliminates the need to update the software of the primary controller whenever a new type of enclosure is introduced or the design of an existing enclosure is modified. Each storage enclosure contains its own media, ensuring that the technician or user is always presented with the correct information, whether old or new, when such storage enclosures are present on a given network.

In example embodiments, the embedded media may include annotated pictures detailing the location of each component within the storage enclosure. As will be seen, such annotations may be provided as pointers, enclosing shapes, or overlaid masks that highlight specific components. For example, an arrow can be added to an image pointing to a relevant service light or handle. In another case, a particular disk drive, power supply, or other component to be replaced can be highlighted on the image. This level of detail may generally enhance the user experience, reducing the potential for errors, and improve overall maintenance efficiency. By storing media on the storage enclosures themselves and facilitating automatic updates to the primary controller, embodiments of the present disclosure address ongoing problems involving outdated media and streamline the management of storage systems. The primary controller remains up to date with the latest instructional content, even as storage enclosures are regularly added or removed from the network.

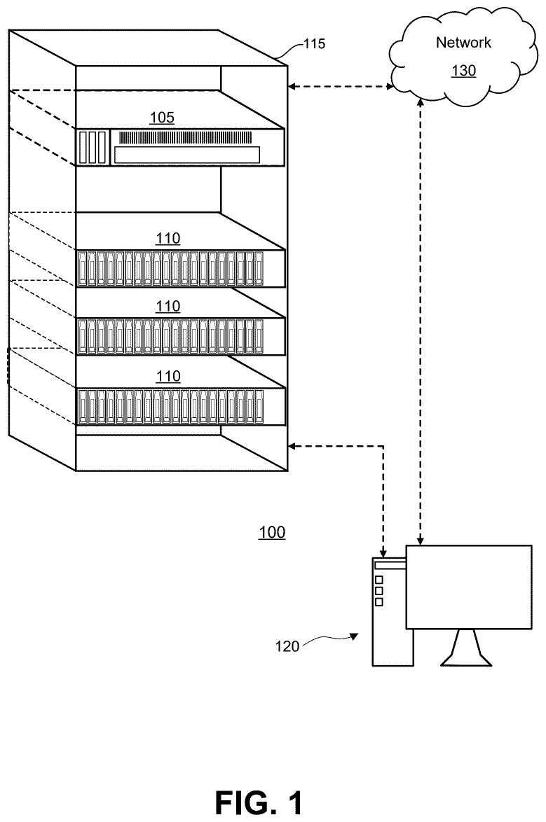

With reference now to FIG. 1, an example data storage system 100 is shown that includes storage enclosures and a primary controller according to various example embodiments. As indicated, the data storage system 100 may include several devices, such as one or more servers 105 and one or more storage enclosures 110, stacked within a device rack 115 to enhance space efficiency. The device rack 115 may include multiple slots, each capable of holding a unit of equipment, such as the illustrated servers 105 or storage enclosures 110. In general, the server 105 may provide resources or data to other computers, known as clients, over a network.

The data storage system 100 may include a connected controller and user interface, which may be referred to as a primary controller 120. The primary controller 120 may connect to and manage the storage enclosures 110 and other network components of the system. The primary controller 120 may be responsible for orchestrating the flow of data between connected storage devices and a network 130. The primary controller 120 may oversee various tasks, including data access, storage management, and system monitoring. The primary controller 120 can be provided via the computer system as software, hardware, or a combination thereof, integrating its functionalities through dedicated circuits, firmware, and programmable logic in hardware, or through software applications and operating systems. Examples of primary controllers include network-attached storage (NAS) controllers, which provide file-level data storage and sharing over a network, storage area network (SAN) controllers, which manage block-level storage for high-performance applications, and unified storage controllers, which offer both file-level and block-level storage capabilities. Other types of primary controllers may also be used.

In example embodiments, the storage enclosure 110 may be a hardware unit that acts as a storage node within the network. The storage enclosure 110 may be designed to house multiple storage devices, such as hard drives (HDDs) or solid-state drives (SSDs), that provide scalable data storage. The storage enclosure 110 may be equipped with drive bays, power supplies, cooling systems, and often includes an embedded controller for managing and monitoring the storage devices. The storage enclosure 110 may connect to servers or networks via high-speed interfaces, enabling data transfer and access. According to various example embodiments, the storage enclosures 110 may include embedded media, as disclosed herein.

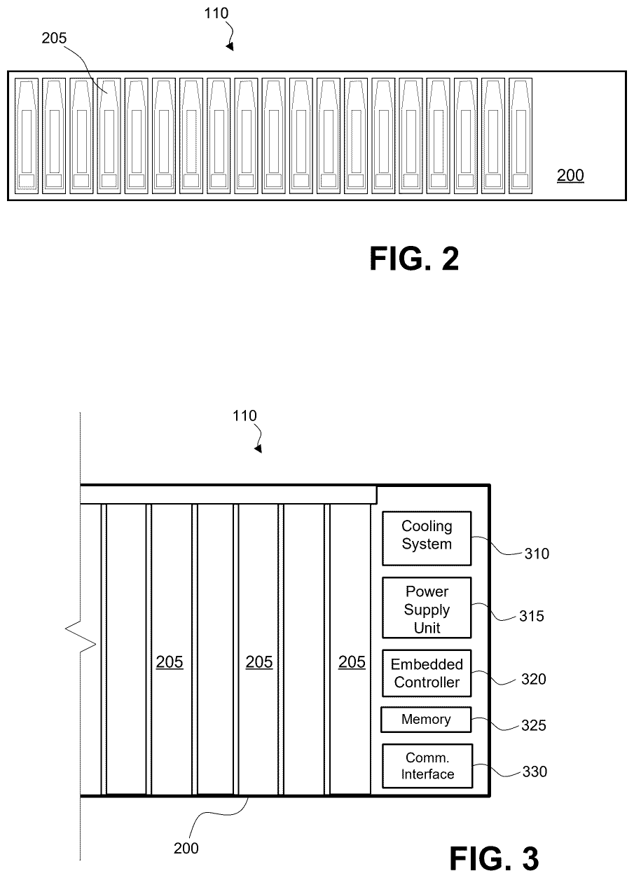

With reference now to FIGS. 2 and 3, illustrations are provided of a storage enclosure 110, which includes stored media files and related functionality according to embodiments of the present disclosure. FIG. 2 shows a front panel 200 of a storage enclosure 110, which may include several slots or drive bays 205. The front panel 200 may be part of an outer encasement that houses internal components, as described below. As will be appreciated, each of the drive bays 205 may be configured to receive a disk drive. The disk drives, for example, may include hard disk drives or solid-state drives. The drive bays 205 may include respective power and data connections for operation of the disk drives installed therewithin. As illustrated, the drive bays 205 may be aligned in parallel and in a row. Other configurations of the drive bays 205 are also possible. For example, the storage enclosure 110 may have more or fewer drive bays 205 in a row. Further, the storage enclosure 110 may include several stacked rows. Various connectors (not shown) may also be provided that facilitate the connection of peripheral devices and power sources.

In FIG. 3, an example internal configuration of a storage enclosure 110 is shown according to example embodiments. Though other configurations are also possible, the internal configuration of the storage enclosure 110 may include a cooling system 310, which includes fans and heat sinks designed to dissipate heat. Power may be provided to the internal components of the storage enclosure 110 via a power supply unit 315, which converts electrical power to the voltages used by the storage enclosure 110.

In example embodiments, the storage enclosure 110 may include an embedded controller 320, which manages various internal functions and interfaces with other subsystems of the enclosure. The embedded controller 320 may be a specialized microcontroller that oversees the operations of the storage enclosure 110. The embedded controller 320 may be responsible for tasks such as monitoring the status of the storage devices, managing data transfers, and ensuring the overall health and performance of the storage enclosure 110. The embedded controller 320 may connect to a local memory 325. In example embodiments, the media files related to the storage enclosure 110 may be stored in the memory 325. The memory 325 may include non-volatile memory or read-only memory.

In example embodiments, the storage enclosure 110 includes a communication interface 330 that enables connectivity with networks and external devices, such as a primary network controller. In example embodiments, the communication interface 330, which also may be referred to as a network interface, may include several components to facilitate such communication. For example, one or more ports, such as an Ethernet port, may be provided as a connection point for wired network communication. Such ports may allow the storage enclosure 110 to connect to a local area network (LAN) or wide area network (WAN). The communication interface 330 may include a Network Interface Card (NIC) that enables the storage enclosure 110 to communicate over a network, handling data transmission and reception. The storage enclosure 110 may include switch ports or router ports for connecting to network switches or routers, respectively. The communication interface 330 may further include wireless network interfaces, such as Wi-Fi or Bluetooth, allowing for wireless communication.

The storage enclosure 110 may include a physical outer encasement or housing that contains its components and subsystems. The housing is typically designed to provide access to the storage enclosure 110 for maintenance and upgrades. The storage enclosure 110 may further include firmware, which may be embedded in a motherboard (not shown). The firmware may initialize and manage hardware components during boot-up. In example embodiments, the media files may be embedded within the firmware of the storage enclosure 110. The storage enclosure 110 may further include an operating system and other software or other applications that manage hardware resources and operational characteristics in accordance with functionality disclosed herein.

As stated, example embodiments of the storage enclosure 110 include media files stored on a local memory, such as the memory 325. The media files may be usable, for example, by a primary controller, to generate respective instructional content on a user interface. The instructional content may be related to performing respective service operations with respect to the storage enclosure. As used herein, the term “media file” refers to a type of digital file that contains media content such as text, audio, images, animations, video, or interactive content. For example, a media file may be an audio file (such as MP3, WAV, and AAC), a video file (such as MP4, AVI, and MOV), an image file (such as JPEG, PNG, and GIF), an animation file (such as an animated GIF), a text file, or an interactive content file (such as HTML5 content and interactive presentations). In example embodiments, the media files may include multimedia files that contain multiple types of media content within a single file. As will be appreciated, a multimedia file is a type of digital file that contains multiple forms of content such as text, audio, images, animations, video, and/or interactive content. The media/multimedia files stored on the storage enclosure 110 each may be rendered to generate instructional content related to performing service operations on the storage enclosure 110, as described more below.

In example embodiments, the embedded controller 320 is configured to detect a triggering event signaling an uploading process. In response to the detection of the triggering event, the embedded controller 320 may be configured to upload, via the communication interface 330 to an external device for storage thereon, the media files. In example embodiments, the triggering event may include the storage enclosure 110 having been determined to have established an initial connection with the external device. Alternatively, the triggering event may include the embedded controller being determined to have received a request from the external device. For example, the request may be one that is prompted during an initial configuration routine related to adding a storage enclosure to a particular data storage system. In example embodiments, the external device may be a primary controller configured to manage storage resources associated with the storage enclosure 110 and other storage enclosures (e.g., other storage enclosures included within a given network) within a data storage system. As will be appreciated, the triggering event may result in the media stored on the storage enclosure 110 being uploaded to the external device (e.g., primary controller) automatically and, moreover, as part of the usual course of adding the storage enclosure 110 to a particular network. This ensures that, if a storage enclosure 110 has been added to a given network (e.g., gone through the steps of being integrated into the network), then the associated primary controller has received the corresponding media files for instructional content related to it.

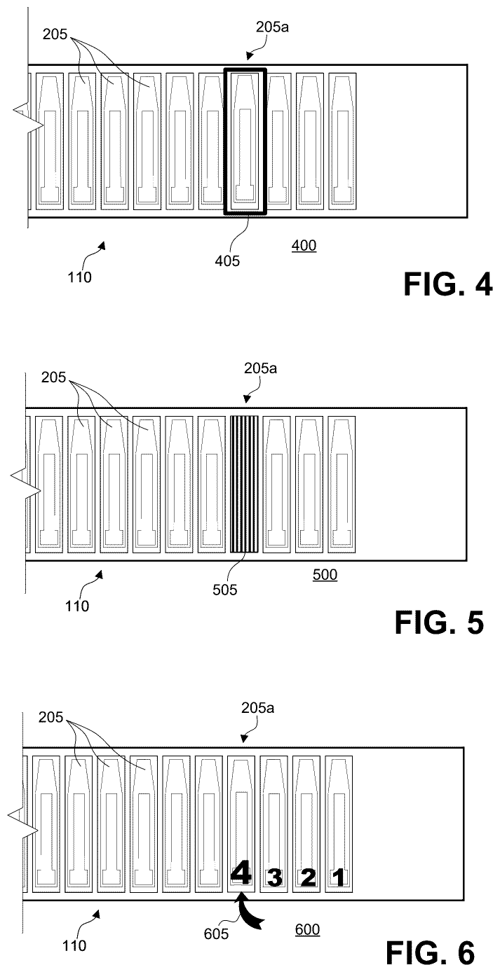

With reference to FIGS. 4-8, in example embodiments, the stored media files may include images or videos depicting the instructional content related to the storage enclosure 110. For example, the videos of the media files may include a video showing a technician demonstrating the correct way to perform a service operation on the storage enclosure 110. In example embodiments, the media files may include respective groups of images depicting the instructional content. Each group of images, when rendered, may display a visual step-by-step guide for performing the service operation. In example embodiments, the media files may include respective images that have been graphically annotated to show respective locations for respective components within the storage enclosure 110. As discussed more below, in example embodiments, the graphical annotations may be provided as an enclosing polygon, a mask, or an arrow or pointer that serves to highlight a particular component.

With specific reference now to FIG. 4, an image 400 depicts a rendered media file showing instructional content according to example embodiments. It should be understood that the image 400 is provided as an example of the types of images that can be included in the media files stored on a storage enclosure. Other types of images may also be included, such as images relating to different components or relating to other types of instructional content. Regarding the image 400, a storage enclosure 110 is shown, featuring a row of drive bays 205, each configured to house a respective disk drive. In this embodiment, the image 400 includes a graphical annotation 405 designed to assist technicians in distinguishing a particular drive bay 205a within the row of other drive bays 205. Such distinction may be useful, for example, when it is determined that the particular drive bay 205a houses a disk drive that is to be replaced because of a detected fault. In the illustrated image 400, the particular drive bay 205a is highlighted using a graphical annotation 405, which is an enclosing polygon, e.g., a polygon, such as the rectangle shown, that surrounds the particular drive bay 205a and thereby identifies it. The graphical annotation 405 is formed to clearly indicate the location of the particular drive bay 205a within the row of drive bays 205. In example embodiments, the enclosing polygon may also be shown with additional visual cues, such as, the enclosing polygon may be shown as flashing or made to change color, which may enhance the visual emphasis of it in the image. In this way, a technician accessing the image 400, for example, may be guided to the precise location of a faulty disk drive for replacing it. Such unambiguous visual indication may minimize the risk of errors during disk drive replacement and allow the process to proceed efficiently.

With specific reference now to FIG. 5, an image 500 depicts a rendered media file showing instructional content according to example embodiments. Again, a storage enclosure 110 is shown, featuring a row of drive bays 205, each configured to house a respective disk drive, and the image 500 includes a graphical annotation 505 designed to assist technicians in distinguishing a particular drive bay 205a within the row of other drive bays 205. In the illustrated image 500, the particular drive bay 205a is highlighted using another type of graphical annotation 505, which is a mask, may include an overlay that covers the particular drive bay 205a and thereby identifies it. The mask may be opaque or semi-opaque and may be colored for visual emphasis. The graphical annotation 505 is formed to clearly indicate the location of the particular drive bay 205a within the row of drive bays 205. In example embodiments, the mask also may be shown with additional visual cues, such as, showing the mask as flashing or changing color, which may enhance the visual emphasis of it in the image. A technician accessing the image 500, for example, may be guided to the precise location of a faulty disk drive for replacing it, which may reduce errors and assist in drive replacement.

With specific reference now to FIG. 6, an image 600 depicts a rendered media file showing instructional content according to example embodiments. Again, a storage enclosure 110 is shown, featuring a row of drive bays 205, each configured to house a respective disk drive, and the image 600 includes a graphical annotation 605 designed to assist technicians in distinguishing a particular drive bay 205a within the row of other drive bays 205. In the illustrated image 600, the particular drive bay 205a is highlighted using another type of graphical annotation 605, which is a pointer or arrow that is aimed and positioned to indicate the particular drive bay 205a. In this case, the graphical annotation 605 further includes text for additional instructional content. The text is “4 3 2 1” and is provided in a way so as to assist a technician in quickly determining which number the particular drive bay 205a is from an end of the row (which in this case, the particular drive bay 205a is depicted as being the fourth counting from the right end of the row). Other text may be provided, such as text providing instructions on a particular service operation. The graphical annotation 605 is formed to clearly indicate the location of the particular drive bay 205a within the row of drive bays 205. In example embodiments, the pointer also may be shown with additional visual cues, such as, showing the pointer as flashing or changing color. In each case, a technician accessing the image 600 may be guided to the precise location of a faulty disk drive for replacing it, which may reduce errors and assist in the drive replacement process.

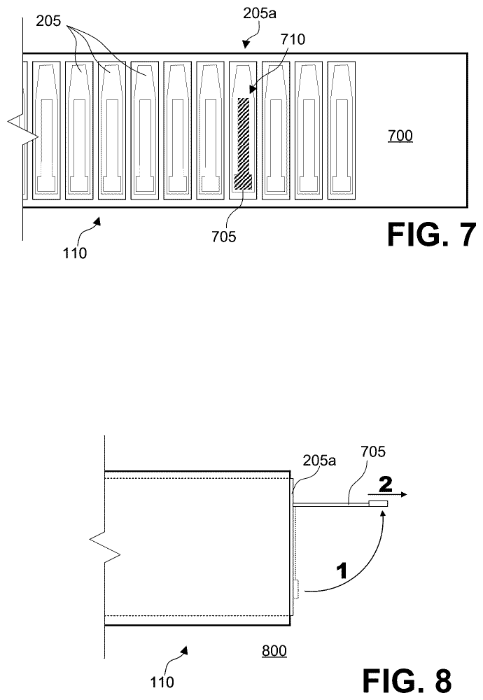

With specific reference now to FIG. 7, an image 700 depicts a rendered media file showing instructional content according to example embodiments. Again, a storage enclosure 110 is shown, featuring a row of drive bays 205, each configured to house a respective disk drive, and the image 700 includes a graphical annotation 705 that is a mask designed to assist technicians in distinguishing a particular component, which in this case is a subcomponent of the particular drive bay 205a identified in FIGS. 4-6. In this case, the subcomponent is a drive locking handle 710. A drive locking handle 710 may be a handle or mechanism attached to a disk drive or drive bay that assists in installation. The drive locking handle 710 may be used when inserting the disk drive or drive bay or disengaging it. The drive locking handle 710 also may be used to lock the disk drive or drive bay in place. In example embodiments, the image 700 may be provided as a follow-up to one of the images described above that identified the particular drive bay 205a within the row of other drive bays 205. Specifically, once the particular drive bay 205a is identified, for example by the image 500, the image 700 may be provided next to highlight a particular subcomponent (e.g., the drive locking handle 710) that is used to perform a service operation. This feature may be used to provide an illustrated step-by-step guide for service operations.

Continuing with the example embodiment, FIG. 8 includes an image 800 that may be provided as a follow-up to FIG. 7. In FIG. 8, a side view of the storage enclosure 110 and the particular drive bay 205 is shown to demonstrate use of the drive locking handle 710 to remove the faulty disk drive. In the image 800, the drive locking handle 710 is depicted in an initial location (via dashed lines) and then shown in a final location. FIG. 800 further includes arrows depicting actions to be performed on the drive locking handle 710. The arrows may be numbered to indicate an order of the actions. Thus, as shown in the image 800, the drive locking handle 710 should first be rotated from its initial position and then may be pulled away from the storage enclosure to dislodge the disk drive. In this way, the instructional content may demonstrate how to perform service operations for the storage enclosure 110. In other example embodiments, the instructional content of FIG. 8 may be provided as an animation or a video that shows the depicted actions being performed.

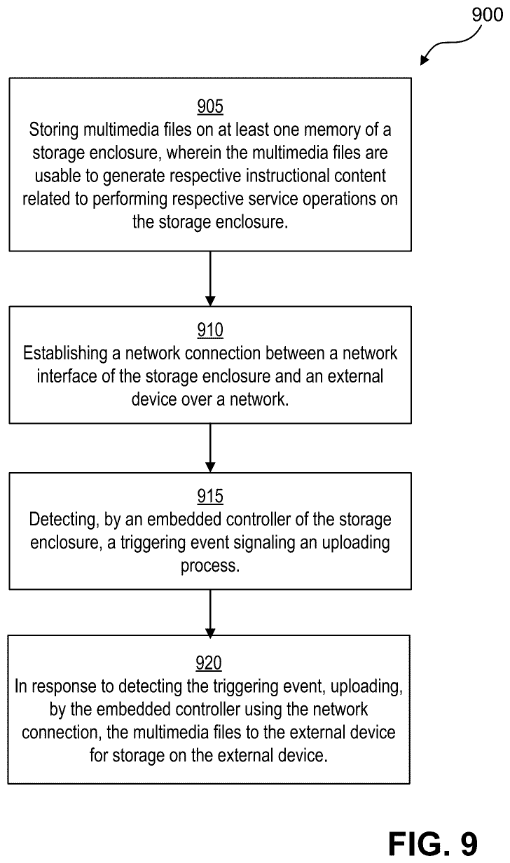

With specific reference to FIG. 9, a method 900 is illustrated related to providing media files on a storage enclosure according to various example embodiments.

At 905, the method 900 may include storing media files on at least one memory of a storage enclosure, wherein the media files are usable to generate respective instructional content related to performing respective service operations on the storage enclosure.

At 910, the method 900 may include establishing a network connection between a network interface of the storage enclosure and an external device over a network.

At 915, the method 900 may include detecting, by an embedded controller of the storage enclosure, a triggering event signaling an uploading process.

At 920, the method 900 may include, in response to detecting the triggering event, uploading, by the embedded controller using the network connection, the media files to the external device for storage on the external device.

In example embodiments, the triggering event may include the storage enclosure having been determined to have established an initial connection with the external device. Alternatively, the triggering event may include the embedded controller being determined to have received a request from the external device.

In example embodiments, the external device may include a primary controller configured to manage storage resources associated with the storage enclosure and other storage enclosures. In example embodiments, the memory may be a read-only memory.

In example embodiments, the media files may include videos depicting the instructional content. The videos of the media files may depict respective correct ways to perform the respective service operations. In example embodiments, the media files may include respective groups of images depicting the instructional content. The respective groups of images, when rendered, may display visual step-by-step guides for performing the respective service operations.

In example embodiments, the media files may include respective images showing respective locations for respective components within the storage enclosure. In example embodiments, the respective images may include respective graphical annotations that visually emphasize the respective components in relation to respective surrounding components. In example embodiments, each graphical annotation may include one of a pointer, an enclosing polygon, or a mask. In example embodiments, the drive bays may be arranged parallel in a row. In such cases, the media files may include respective images of the row, with each image including a graphical annotation that visually emphasizes a unique one of the drive bays over the other drive bays in the row. The graphical annotation of each image of the row may include a mask shaped to overlay the unique one of the drive bays.

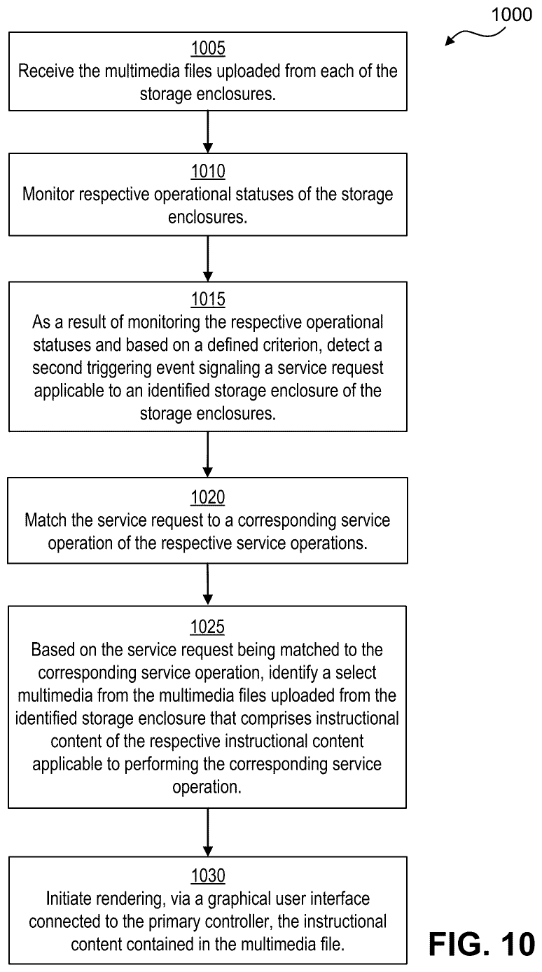

With specific reference to FIG. 10, a method 1000 is illustrated for managing, by a primary controller, media files related to attached storage enclosures according to various example embodiments. The primary controller may manage functions or operations of a data storage system, such as system 100 of FIG. 1. The primary controller may be connected to each of the storage enclosures and configured to manage storage resources associated with the storage enclosures. In example embodiments, the storage enclosures each may include a common configuration that, for each of the storage enclosures, may include: drive bays configured to receive respective disk drives; a memory on which is stored media files usable to generate respective instructional content related to performing respective service operations with respect to the storage enclosure; and an embedded controller configured to detect a first triggering event signaling an uploading process applicable to media files, and, in response to detection of the first triggering event, upload the media files via a network interface to the primary controller.

At 1005, the method 1000 may include receiving, by the primary controller, the media files uploaded from each of the storage enclosures.

At 1010, the method 1000 may include monitoring respective operational statuses of the storage enclosures

At 1015, the method 1000 may include, as a result of monitoring the respective operational statuses and based on a defined criterion, detecting a second triggering event signaling a service request applicable to an identified storage enclosure of the storage enclosures

At 1020, the method 1000 may include matching the service request to a corresponding service operation of the respective service operations

At 1025, the method 1000 may include, based on the service request being matched to the corresponding service operation, identifying a select media file from the media files uploaded from the identified storage enclosure that comprises instructional content of the respective instructional content applicable to performing the corresponding service operation.

At 1030, the method 1000 may include initiating rendering, via a graphical user interface connected to the primary controller, the instructional content contained in the media file.

In example embodiments, the first triggering event may include a storage enclosure of the storage enclosures establishing an initial connection with the primary controller. In alternative embodiments, the first triggering event may include a request received by the embedded controller from the primary controller. The request may have been prompted during an initial configuration routine related to adding a storage enclosure of the storage enclosures to the data storage system.

In example embodiments, the primary controller may include one of a network-attached storage controller or a primary storage array controller. The memory may include a read-only memory.

In example embodiments, the media files may include respective videos depicting the respective instructional content, resulting in respective correct ways being depicted for performance of the respective service operations. In example embodiments, the media files may include respective groups of images depicting the respective instructional content, resulting in respective visual step-by-step guides being depicted for performance of the respective service operations.

In example embodiments, the media files may include respective images showing respective locations for respective components within a storage enclosure of the storage enclosures. At the respective locations, the respective images may include respective graphical annotations that visually emphasize the respective components in relation to surrounding components (e.g., the components that surround the visually emphasized component). In example embodiments, the respective graphical annotations each may include one of a pointer, an enclosing polygon, or a mask.

In example embodiments, the service request may include a request related to a fault corresponding to a disk drive of the respective disk drives in a drive bay of the drive bays in the identified storage enclosure. The drive bay may be arranged parallel to other drive bays within a row. The media file may include an image of the row that is modified with a graphical annotation that visually emphasizes the drive bay over the other drive bays in the row. The graphical annotation may include a mask that overlays at least part of the drive bay.

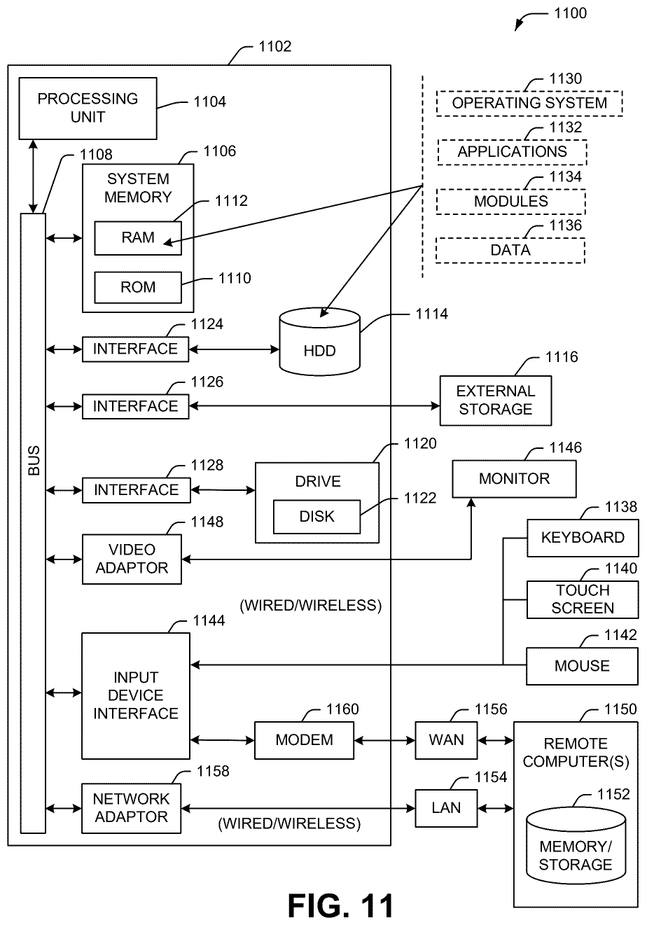

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 may couple system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and a drive 1120, e.g., such as a solid state drive, an optical disk drive, which can read or write from a disk 1122, such as a CD-ROM disc, a DVD, a BD, etc. Alternatively, where a solid-state drive is involved, disk 1122 would not be included, unless separate. While the internal HDD 1114 is illustrated as located within the computer 1102, the internal HDD 1114 can also be configured for external use in a suitable chassis (not shown). Additionally, while not shown in environment 1100, a solid-state drive (SSD) could be used in addition to, or in place of, an HDD 1114. The HDD 1114, external storage device(s) 1116 and drive 1120 can be connected to the system bus 1108 by an HDD interface 1124, an external storage interface 1126 and a drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the . NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can also be connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above, such as, but not limited to, a network virtual machine providing one or more functions of storage or processing of information. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

What is claimed is:

1. A storage enclosure, comprising:
an outer encasement housing drive bays configured to receive respective disk drives, the drive bays comprising respective power and data connections for operation of the respective disk drives installed in the drive bays;
a memory on which is stored media files usable to generate respective instructional content related to performing respective service operations with respect to the storage enclosure;
a network interface; and
an embedded controller configured to detect a triggering event signaling an uploading process, and, in response to detection of the triggering event, upload, via the network interface to an external device for storage thereon, the media files.

2. The storage enclosure of claim 1, wherein the triggering event comprises the storage enclosure having been determined to have established an initial connection with the external device,
wherein the external device comprises a primary controller configured to manage storage resources associated with the storage enclosure and other storage enclosures other than the storage enclosure, and
wherein the memory comprises a read-only memory.

3. The storage enclosure of claim 1, wherein the triggering event comprises the embedded controller being determined to have received a request from the external device;
wherein the external device comprises a primary controller configured to manage storage resources associated with the storage enclosure and other storage enclosures other than the storage enclosure, and
wherein the memory comprises a read-only memory.

4. The storage enclosure of claim 1, wherein the media files comprise videos depicting the instructional content, and wherein the videos show respective correct ways to perform the respective service operations.

5. The storage enclosure of claim 1, wherein the media files comprise respective groups of images depicting the instructional content, and wherein the respective groups of images, when rendered, display respective visual step-by-step guides to performing the respective service operations.

6. The storage enclosure of claim 1, wherein the media files comprise respective images showing respective locations for respective components within the storage enclosure, the respective images comprising respective graphical annotations that visually emphasize the respective components in relation to respective surrounding components.

7. The storage enclosure of claim 6, wherein each graphical annotation of the respective graphical annotations comprises one of a pointer, an enclosing polygon, or a mask.

8. The storage enclosure of claim 6, wherein the drive bays are arranged parallel in a row,
wherein the media files comprise respective images of the row, and
wherein each image of the respective images of the row comprises a graphical annotation that visually emphasizes a unique one of the drive bays over the other drive bays in the row other than the unique one.

9. The storage enclosure of claim 8, wherein the graphical annotation of each image of the respective images of the row comprises a mask shaped to overlay the unique one of the drive bays.

10. A system, comprising:
storage enclosures in a data storage system; and
a primary controller, connected to each of the storage enclosures, configured to manage storage resources associated with the storage enclosures,
wherein the storage enclosures each comprise a common configuration, and wherein the common configuration for a storage enclosure of the storage enclosures comprises:
drive bays configured to receive respective disk drives, the drive bays comprising respective power and data connections for operation of the respective disk drives installed in the drive bays;
a memory on which is stored media files usable to generate respective instructional content related to performing respective service operations with respect to the storage enclosure; and
an embedded controller configured to detect a first triggering event signaling an uploading process applicable to media files, and, in response to detection of the first triggering event, upload the media files via a network interface to the primary controller,
wherein the primary controller is further configured to:
receive the media files uploaded from each of the storage enclosures;
monitor respective operational statuses of the storage enclosures;
as a result of monitoring the respective operational statuses and based on a defined criterion, detect a second triggering event signaling a service request applicable to an identified storage enclosure of the storage enclosures;
match the service request to a corresponding service operation of the respective service operations;
based on the service request being matched to the corresponding service operation, identify a select media file from the media files uploaded from the identified storage enclosure that comprises instructional content of the respective instructional content applicable to performing the corresponding service operation; and
initiate rendering, via a graphical user interface connected to the primary controller, the instructional content contained in the media file.

11. The system of claim 10, wherein the first triggering event comprises a storage enclosure of the storage enclosures establishing an initial connection with the primary controller,
wherein the primary controller comprises one of a network-attached storage controller or a primary storage array controller, and
wherein the memory comprises a read-only memory.

12. The system of claim 10, wherein the first triggering event comprises a request received by the embedded controller from the primary controller,
wherein the request was prompted during an initial configuration routine related to adding a storage enclosure of the storage enclosures to the data storage system,
wherein the primary controller comprises one of a network-attached storage controller or a primary storage array controller, and
wherein the memory comprises a read-only memory.

13. The system of claim 10, wherein the media files comprise respective videos depicting the respective instructional content, resulting in respective correct ways being depicted for performance of the respective service operations.

14. The system of claim 10, wherein the media files comprise respective groups of images depicting the respective instructional content, resulting in respective visual step-by-step guides being depicted for performance of the respective service operations.

15. The system of claim 10, wherein the media files comprise respective images showing respective locations for respective components within a storage enclosure of the storage enclosures, and
wherein, at the respective locations, the respective images comprise respective graphical annotations that visually emphasize the respective components in relation to surrounding components that surround the respective components.

16. The system of claim 15, wherein the respective graphical annotations each comprises one of a pointer, an enclosing polygon, or a mask.

17. The system of claim 15, wherein the service request comprises a request related to a fault corresponding to a disk drive of the respective disk drives in a drive bay of the drive bays in the identified storage enclosure,
wherein the drive bay is in a row and arranged parallel to other drive bays in the row other than the drive bay, and
wherein the media file comprises an image of the row that is modified with a graphical annotation that visually emphasizes the drive bay over the other drive bays.

18. The system of claim 17, wherein the graphical annotation comprises a mask that overlays at least part of the drive bay.

19. A method, comprising:
storing media files on at least one memory of a storage enclosure, wherein the media files are usable to generate respective instructional content related to performing respective service operations on the storage enclosure;
establishing a network connection between a network interface of the storage enclosure and an external device over a network;
detecting, by an embedded controller of the storage enclosure, a triggering event signaling an uploading process; and
in response to detecting the triggering event, uploading, by the embedded controller using the network connection, the media files to the external device for storage on the external device,
wherein the triggering event comprises the embedded controller being determined to have received a request from the external device.

20. The method of claim 19, wherein the external device comprises a primary controller configured to manage storage resources associated with the storage enclosure and other storage enclosures other than the storage enclosure,
wherein the media files comprise respective groups of images depicting the instructional content, and
wherein the respective groups of images, when rendered, display respective visual step-by-step guides related to performing the respective service operations.
